(19) United States
(12) Patent Application Publication
(10) Pub. No.: US 2024/0370034 A1
(43) Pub. Date: Nov. 7, 2024

(54) PATH PLANNING DEVICE

(71) Applicant: HONDA MOTOR CO., LTD., Tokyo (JP)

(72) Inventor: Andrii Pydin, Wako-shi (JP)

(73) Assignee: HONDA MOTOR CO., LTD., Tokyo (JP)

(21) Appl. No.: 18/772,346

(22) Filed: Jul. 15, 2024

Related U.S. Application Data
(63) Continuation of application No. PCT/JP2022/002481, filed on Jan. 24, 2022.

(51) Int. Cl. G05D 1/644; G05D 1/65; G05D 1/667

(52) U.S. Cl. CPC G05D 1/644; G05D 1/65; G05D 1/667

(57) ABSTRACT

A path planning device for planning a path on which a machine capable of transporting an object moves is provided. The device acquires a graph including a plurality of nodes corresponding to a plurality of points and a plurality of edges corresponding to a plurality of roads connecting the plurality of points, determines weights to be assigned to the plurality of edges, and selects a start point and an end point from the plurality of nodes, and determine a path from the start point to the end point based on the weights assigned to the plurality of edges. The weights are determined based on at least a weight of the object transported by the machine during movement on the road corresponding to each edge, and a difference in altitude between points corresponding to two nodes connected by each edge.

### CROSS-REFERENCE TO RELATED APPLICATION(S)

This application is a continuation of International Patent Application No. PCT/JP2022/002481 filed on Jan. 24, 2022, the entire disclosure of which is incorporated herein by reference.

### BACKGROUND OF THE INVENTION

### Field of the Invention

The present disclosure relates to a path planning device.

### Description of the Related Art

Various techniques for planning a movement path of an autonomous mobile robot have been proposed. In the technique described in Japanese Patent Laid-Open No. 2006-195969, a path from a current position of a robot to a destination is determined so that a time, a distance, or energy consumption is optimized. An amount of energy consumed when a machine such as a robot transports an object depends not only on a movement distance but also on a weight of the object and a difference in altitude between the movement paths. Since the technique described in the above document determines a path without using such information, it is not always possible to plan a path with low consumed energy.

### SUMMARY OF THE INVENTION

One aspect of the present disclosure provides a technique for planning a path with low consumed energy. According to an embodiment, a path planning device for planning a path on which a machine capable of transporting an object moves, the path planning device comprising: at least one processor circuit and a memory storing instructions, that when executed by the processor circuit, cause the processor circuit to at least: acquire a graph including a plurality of nodes corresponding to a plurality of points and a plurality of edges corresponding to a plurality of roads connecting the plurality of points; determine weights to be assigned to the plurality of edges; and select a start point and an end point from the plurality of nodes, and determine a path from the start point to the end point based on the weights assigned to the plurality of edges, wherein the weights to be assigned to the plurality of edges are determined based on at least a weight of the object transported by the machine during movement on the road corresponding to each edge, and a difference in altitude between points corresponding to two nodes connected by each edge is provided.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a block diagram illustrating a hardware configuration example of a server and a vehicle according to some embodiments;

FIG. 2 is a block diagram illustrating a functional configuration example of the server according to some embodiments;

FIG. 3 is a diagram illustrating a map of a workplace according to some embodiments;

FIG. 4 is a diagram illustrating a graph according to some embodiments;

FIG. 5 is a diagram illustrating an image indicating weights according to some embodiments;

FIG. 6 is a flowchart illustrating a method for planning a path according to some embodiments; and

FIG. 7 is a flowchart illustrating another method for planning a path according to some embodiments.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

Some embodiments of the present disclosure relate to a technique for planning a path on which a machine capable of transporting an object moves. The object that can be transported by the machine may be an inanimate object or a living object. The living object may be any of a plant, an animal, and a human. The object (In particular, the inanimate object) that can be transported by the machine may also be referred to as a load. The machine capable of transporting the object may be a vehicle that moves by rotating wheels. Such movement of the vehicle may also be referred to as traveling. Alternatively, the machine capable of transporting the object may be a robot that moves by sequentially moving a plurality of legs. Such movement of the robot may also be referred to as walking. The transportation of the object by the machine may be performed by a machine loading an object, may be performed by a machine pulling an object, or may be performed in other manners.

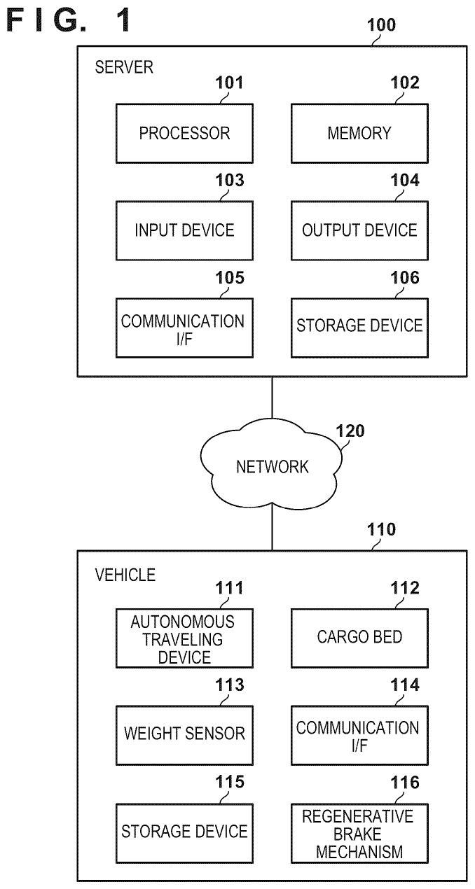

A hardware configuration example of a path planning device according to some embodiments will be described with reference to FIG. 1. In the embodiment illustrated in FIG. 1, a server 100 functions as the path planning device. That is, the server 100 plans a path on which a machine capable of transporting an object moves. In the embodiment illustrated in FIG. 1, a vehicle 110 will be described as an example of the machine capable of transporting an object. The vehicle 110 in the following description may be replaced with another machine.

The server 100 has a processor 101, a memory 102, an input device 103, an output device 104, a communication interface (I/F) 105, and a storage device 106. These components are for describing the present embodiment, and the server 100 may have other components. In addition, in the embodiment, the server 100 may not have all these components.

The processor 101 controls the entire server 100. Specifically, the processor 101 executes a program read into the memory 102 to execute an operation defined by the program. As described in detail below, the processor 101 executes an operation for planning a path on which the vehicle 110 travels. The processor 101 may be a single processor or a set of a plurality of processors. The processor 101 includes, for example, a central processing unit (CPU).

The memory 102 stores programs and data related to the operation of the server 100. The memory 102 may store temporary data during operation of the server 100. The memory 102 includes, for example, a read only memory (ROM) or a random access memory (RAM).

The input device 103 is a device for receiving an input from a user of the server 100. The input device 103 may include, for example, one or more of a keyboard, a mouse, a touch panel, and the like. The output device 104 is a device for outputting information to the user of the server 100. The output device 104 may include, for example, one or more of a display, a speaker, and the like. The input device 103 and the output device 104 may be integrally configured as a touch screen.

The communication I/F 105 is a device for the server 100 to communicate with an external device. The communication with the external device may be wired communication, wireless communication, or both. When the communication I/F 105 performs wired communication, the communication I/F 105 includes, for example, a network card. When the communication I/F 105 performs wireless communication, the communication I/F 105 includes, for example, an antenna and a signal processing circuit.

The storage device 106 stores information used in the operation of the server 100. As will be described in detail below, the storage device 106 may store map information, a work plan, vehicle information, and the like. The storage device 106 includes, for example, a hard disk drive (HDD) or a solid state drive (SSD).

The vehicle 110 has an autonomous traveling device 111, a cargo bed 112, a weight sensor 113, a communication interface (I/F) 114, a storage device 115, and a regenerative brake mechanism 116. These components are for describing the present embodiment, and the vehicle 110 may have other components. In some embodiments, the vehicle 110 may not have all these components.

The autonomous traveling device 111 is a device for autonomously traveling the vehicle 110. The autonomous traveling means traveling without being operated by a human. The autonomous traveling device 111 may have a control circuit that controls an actuator related to driving, braking, and steering of the vehicle, a sensor for recognizing an outside world of the vehicle 110, and a sensor for measuring a geographical position of the vehicle 110. The sensor for recognizing the outside world of the vehicle 110 may include, for example, one or more of a camera, a radar, a light detection and ranging (LiDAR), and the like. The sensor for measuring the geographical position of the vehicle 110 may be, for example, a global navigation satellite system (GNSS) sensor.

The cargo bed 112 is equipment for mounting an object. The cargo bed 112 may be exposed to an outside of the vehicle 110 or may be inside a vehicle body of the vehicle 110. As described above, the vehicle 110 may tow the object instead of transporting the object mounted on the cargo bed 112. In this case, the vehicle 110 may not have the cargo bed 112. The weight sensor 113 is a sensor for measuring a weight of the object mounted on the cargo bed 112.

The communication I/F 114 is a device for the vehicle 110 to communicate with an external device. The communication with the external device may be wired communication, wireless communication, or both. When the communication I/F 114 performs wired communication, the communication I/F 114 includes, for example, a network card. When the communication I/F 114 performs wireless communication, the communication I/F 114 includes, for example, an antenna and a signal processing circuit.

The storage device 115 stores information used in the operation of the vehicle 110. As will be described in detail below, the storage device 115 may store vehicle information and the like. The storage device 115 includes, for example, an HDD or an SSD. The regenerative brake mechanism 116 is a device that converts kinetic energy of the vehicle 110 into electric energy.

The server 100 and the vehicle 110 may be able to communicate with each other through a network 120. The network 120 may be a wide area network such as the Internet or a local network such as a wireless local area network (LAN).

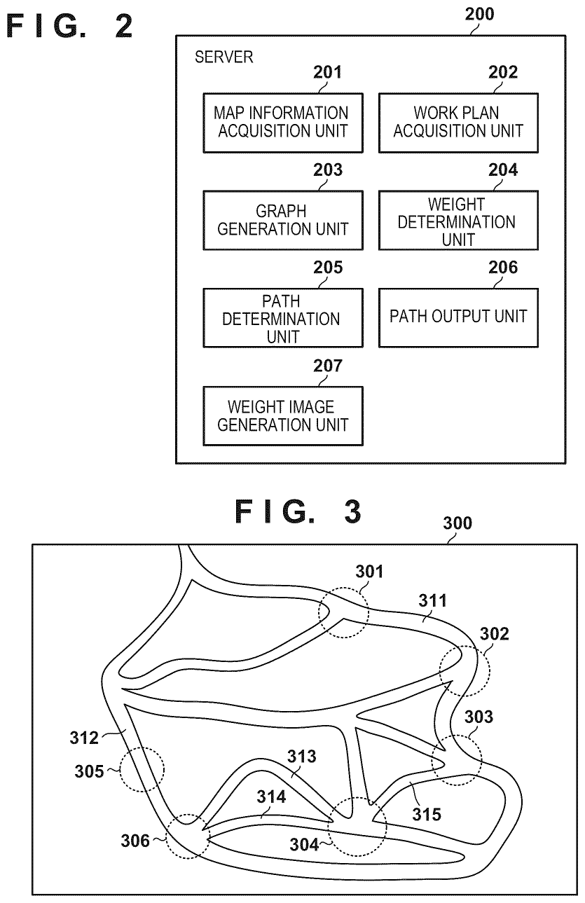

Functional blocks of the server 100 functioning as the path planning device will be described with reference to FIG. 2. The server 100 has, for example, a map information acquisition unit 201, a work plan acquisition unit 202, a graph generation unit 203, a weight determination unit 204, a path determination unit 205, a path output unit 206, and a weight image generation unit 207. Each functional block may be realized, for example, by the processor 101 executing a command of a program read into the memory 102. Instead of this, some or all of the functional blocks of the server 100 may be realized by a dedicated circuit such as an application specific integrated circuit (ASIC) or a field programmable gate array (FPGA) instead of being realized by a general-purpose circuit such as a CPU.

The map information acquisition unit 201 acquires map information of a workplace where the vehicle 110 is scheduled to perform a transportation work. The map information includes information on a plurality of points and information on a plurality of roads. The information on the plurality of points includes plane coordinates and a height of each point. The plane coordinates of each point may be designated by, for example, latitude and longitude. Alternatively, the plane coordinates of each point may be relative coordinates with respect to a specific reference point. The height of each point may be a height from a sea surface (that is, elevation). Alternatively, the height of each point may be a relative height with respect to a specific reference point.

The information on the plurality of roads indicates one or more points through which each road passes. Further, the information on the road may include a length of the road (for example, a path), a width of the road, a state of the road (for example, slipperiness and the like), and a condition of traveling on the road (for example, speed limit, weight limit, height limit, one-way, and the like).

The map information acquisition unit 201 may acquire the map information by reading the map information from the storage device 106. Alternatively, the map information acquisition unit 201 may acquire the map information by receiving the map information from another device (for example, another server that provides map information). The map information may be created by a user of the server 100 or a third party investigating a work scheduled place.

The work plan acquisition unit 202 acquires a work plan related to the transportation work scheduled to be performed by the vehicle 110. The work plan indicates a point (hereinafter, referred to as a work start point) where the vehicle 110 starts the work, a point (hereinafter, referred to as a via-point) through which the vehicle 110 passes, and a point (hereinafter, referred to as a work end point) where the vehicle 110 ends the work. The work start point, the via-point, and the work end point are collectively referred to as a work point. The work start point may be a parking lot of the vehicle 110 or may be another place. When the vehicle 110 autonomously moves to perform the transportation work, the vehicle 110 may be moved to the work start point by a person. The work end point may be a parking lot of the vehicle 110 or another place. The via-point may be a point where the vehicle 110 loads and unloads an object. In a case where the loading and unloading of the object is performed at the via-point, the work plan may indicate a weight of the object loaded on the vehicle 110 at the via-point or a weight of the object unloaded from the vehicle 110 at the via-point. When there are a plurality of via-points, the work plan may indicate an order in which the vehicle 110 passes through the plurality of points. The work point is selected from the plurality of points included in the map information. When the work point desired to be designated is not included in the map information, a planner of the work plan may check information on the work point desired to be designated and update the map information using this information.

The work plan may include information on the vehicle 110 used for the transportation work. The information on the vehicle 110 may include attributes of the vehicle 110 (for example, a weight, a vehicle width, and a vehicle height) and performance of the vehicle 110 (for example, energy conversion efficiency, presence or absence of the regenerative brake mechanism, energy recovery efficiency of the regenerative brake mechanism, and a braking distance with respect to a specific speed). Furthermore, the work plan may include a range of the braking distance (for example, within 10 m) to be satisfied by the vehicle 110 in operation.

The work plan acquisition unit 202 may acquire the work plan by reading the work plan from the storage device 106. Alternatively, the work plan acquisition unit 202 may acquire the work plan by receiving the work plan from another device (for example, another server that provides a work plan). The work plan may be created by the user of the server 100 or the third party.

The graph generation unit 203 generates a graph representing a workplace where the transportation work is scheduled to be performed based on the map information and the work plan. The graph is a data structure constituted by one or more nodes and one or more edges representing a connection relationship of the one or more nodes. The graph generation unit 203 generates a node corresponding to a work point included in the work plan and a node corresponding to a point at which three or more roads are connected in the map information. In addition, the graph generation unit 203 generates an edge connecting two nodes corresponding to two points where the vehicle 110 can directly move (that is, it does not pass through a point corresponding to another node) through a road. As described above, the generated graph includes nodes corresponding to a plurality of points and a plurality of edges corresponding to a plurality of roads connecting the plurality of points.

The graph generation unit 203 generates a directed graph in which each edge has a direction. In a case where two points corresponding to two nodes are separately connected by two or more roads, the graph generation unit 203 generates an edge for each of the two or more roads. Even when there is a road connecting the two points, the graph generation unit 203 may not generate an edge corresponding to the road when the vehicle 110 cannot pass through the road (for example, the width of the vehicle 110 exceeds the road width, or the vehicle 110 does not satisfy the height limit or weight limit of the road).

An example of the graph generated by the graph generation unit 203 will be described with reference to FIGS. 3 and 4. FIG. 3 indicates a map 300 of the workplace, and FIG. 4 indicates a graph 400 generated based on the map 300. The map 300 includes a plurality of points including points 301 to 306 and a plurality of roads including roads 311 to 315. In the work plan, it is assumed that the point 301 is designated as a work start point, the points 302 and 305 are designated as via-points, and the point 301 is designated as a work end point. In this example, the work start point and the work end point coincide with each other, but these may be different.

The graph generation unit 203 generates nodes 1 to 9 corresponding to points where three or more roads are connected in the map information. Further, the graph generation unit 203 generates a node corresponding to the work point. The node 2 corresponding to the work start point and the work end point (point 301) and the node 3 corresponding to one via-point (point 302) have already been generated. Therefore, the graph generation unit 203 generates a node 10 corresponding to a remaining via-point (point 305).

Thereafter, when the vehicle 110 can move directly (that is, it does not pass through a point corresponding to another node) from a point corresponding to a certain node (referred to as a node A) to a point corresponding to another node (referred to as a node B), the graph generation unit 203 generates an edge directed from the node A toward the node B. For example, it is assumed that the vehicle 110 is bidirectionally movable between the point 301 and the point 302 through the road 311. In this case, the graph generation unit 203 generates an edge 401 from the node 2 toward the node 3 and an edge 402 from the node 3 toward the node 2. It is assumed that the vehicle 110 can move from the point 303 to the point 304 through the road 315, but cannot directly move from the point 304 to the point 303 because the road 315 is one-way. In this case, the graph generation unit 203 generates an edge 403 from the node 6 toward the node 7, and does not generate an edge from the node 7 toward the node 6. It is assumed that the vehicle 110 is bidirectionally movable between the point 304 and the point 306 through each of the road 313 and the road 314. In this case, the graph generation unit 203 generates edges 404 and 405 corresponding to the road 313 and edges 406 and 407 corresponding to the road 314. As described above, the graph 400 is generated.

The weight determination unit 204 determines weights to be assigned to each edge of the graph generated by the graph generation unit 203. These weights are used to solve a shortest path problem described below. The weight determination unit 204 determines the weights to be assigned to each edge based on at least a weight of the object transported by the vehicle 110 during movement on a road corresponding to each edge and a difference in altitude between points corresponding to two nodes connected by each edge. Furthermore, the weight determination unit 204 may determine the weights to be assigned to each edge further based on at least one of a distance between the points corresponding to the two nodes connected by each edge, an upper limit speed during movement on the road corresponding to each edge, and an amount of energy recovered by the regenerative brake mechanism 116.

Hereinafter, an example of a method for determining the weight of the edge from the node A toward the node B will be described. A point corresponding to the node A is represented by a point A, and a point corresponding to the node B is represented by a point B. The weight determination unit 204 calculates an energy amount Eₕ consumed by the vehicle 110 when the vehicle 110 ascends or descends from a height of the point A to a height of the point B according to the following Equation 1.

$${E}_{h} = ( {m}_{w} + {m}_{1} ) gh / c \qquad ( Equation 1 )$$

Here, m_{w} represents a weight of the vehicle 110, m₁ represents a weight of the object transported by the vehicle 110, g represents a gravitational acceleration, h represents a value obtained by subtracting the height of the point A from the height of the point B, and c represents a drive system efficiency of the vehicle 110. m_{w} and m₁ may be determined based on the work plan. When the vehicle 110 performs manned traveling, m₁ may include a weight of a passenger of the vehicle 110. The drive system efficiency c represents an amount of energy consumed by the vehicle 110 for changing a unit amount of potential energy. As the value of c is larger, the vehicle 110 can change the unit amount of potential energy with less energy consumption. When h is positive (that is, in a case where the edge corresponds to an uphill), Eₕ is positive, and when h is negative (that is, in a case where the edge corresponds to a downhill), Eₕ is negative.

Subsequently, the weight determination unit 204 calculates a converted distance Lᵣ of the edge according to the following Equation 2.

$${L}_{r} = L \times ( E + {E}_{h} ) / E \qquad ( Equation 2 )$$

Here, L represents a distance between points (that is, the point A and the point B) corresponding to two nodes connected by an edge, E represents an amount of energy consumed by the vehicle 110 for moving by a distance L on a flat road, and Eₕ represents an amount of energy calculated by Equation (1). The distance L between the points corresponding to the two nodes connected by the edge may be a linear distance between the two points, or may be a road path corresponding to the edge.

Even when the distance L between the two points is the same, the converted distance Lᵣ has a larger value when the vehicle 110 travels on the uphill and a smaller value when the vehicle 110 travels on the downhill, as compared with a case where the vehicle 110 travels on the flat road. In addition, when the vehicle 110 travels on the uphill, the converted distance Lᵣ has a larger value as an inclination is larger. When the vehicle 110 travels on the downhill, the converted distance L has a smaller value as the inclination is larger.

When a value h obtained by subtracting the height of the point A from the height of the point B is smaller than a threshold (for example, 1 m), the weight determination unit 204 may calculate the converted distance Lᵣ as Eₕ=0. In this case, the converted distance Lᵣ is equal to the distance L.

Subsequently, the weight determination unit 204 determines an upper limit speed v of the vehicle 110 during movement on the road corresponding to the edge. First, when a speed limit (for example, legal speed) is defined for the road corresponding to the edge, this speed limit is a candidate for the upper limit speed v. In addition, when the upper limit speed (for example, 30 km/h) of the vehicle 110 is defined by the work plan or the like, this upper limit speed is a candidate for the upper limit speed v. When a condition related to the braking distance of the vehicle 110 is defined by the work plan or the like, the upper limit speed satisfying this condition is a candidate for the upper limit speed v. For example, it is assumed that a requirement that the vehicle 110 stops within 10 m from the start of braking is imposed by the work plan or the like. The upper limit of the speed at which the vehicle 110 stops within 10 m is assumed to be 25 km/h. In this case, the weight determination unit 204 sets the upper limit speed (25 km/h) as a candidate for the upper limit speed v.

The braking distance of the vehicle 110 may vary depending on the weight of the object transported by the vehicle 110. Therefore, the weight determination unit 204 may determine the upper limit speed that satisfies the condition related to the braking distance based on the performance of the vehicle 110 acquired from the work plan or the like and the weight of the object transported by the vehicle 110. Furthermore, the braking distance of the vehicle 110 may also vary depending on a state (slipperiness) of the road on which the vehicle 110 is traveling. Therefore, the weight determination unit 204 may determine the upper limit speed that satisfies the condition related to the braking distance further based on the state (slipperiness) of the road on which the vehicle 110 is traveling. The state of the road on which the vehicle 110 is traveling may vary depending on factors such as weather. Therefore, the weight determination unit 204 may determine the upper limit speed that satisfies the condition related to the braking distance further based on the factors such as the weather. When there are a plurality of candidates for the upper limit speed, a minimum value among these candidates is the upper limit speed v.

Subsequently, the weight determination unit 204 calculates a weight w of the edge according to the following Equation 3.

$$w = {L}_{r} / v \qquad ( Equation 3 )$$

Here, Lᵣ represents the converted distance calculated by Equation (2), and v represents the upper limit speed described above. The weight w calculated in this manner is a value based on the amount of energy consumed by the vehicle 110 moving on the edge and the time required to move between the points corresponding to the two nodes connected by the edge. The weight w has a larger value as the amount of energy consumed by the vehicle 110 is larger, and has a larger value as the time required to move between the points corresponding to the two nodes connected by the edge is longer.

When the vehicle 110 has the regenerative brake mechanism 116, the weight determination unit 204 may determine the weights to be assigned to each edge further based on the amount of energy recovered by the regenerative brake mechanism 116. When the point B is lower than the point A (that is, when h<0), the vehicle 110 can recover energy using the regenerative brake mechanism 116 while traveling on the road corresponding to the edge. The weight determination unit 204 calculates an energy amount Eᵣ recovered by the regenerative brake mechanism 116 according to the following Equation 4.

$${E}_{r} = - ( {m}_{w} + {m}_{1} ) {ghc}_{r} \qquad ( Equation 4 )$$

Here, m_{w}, m₁, g, and h are the same as in Equation 1. cᵣ represents energy recovery efficiency by the regenerative brake mechanism 116.

Furthermore, the weight determination unit 204 calculates the converted distance Lᵣ of the edge according to the following Equation 2′.

$${L}_{r} = L \times ( E + {E}_{h} - {E}_{r} ) / E \qquad ( Equation {2}^{′} )$$

Since the converted distance Lᵣ calculated according to Equation 2′ is further based on the amount of energy recovered by the regenerative brake mechanism 116, the weight w is more appropriately calculated. When the weight w has a negative value, the shortest path problem may not be solved. Therefore, the weight determination unit 204 may set the weight to 0 for the edge whose weight w is negative.

The path determination unit 205 selects a start point and an end point from a plurality of nodes of the graph generated by the graph generation unit 203, and determines a path from the start point to the end point based on the weights assigned to the plurality of edges. For example, the path determination unit 205 determines a shortest path with a minimum sum of weights. The shortest path may be determined by, for example, the Dijkstra method, may be determined by the Berman-Ford method, or may be determined by using another algorithm. A method for determining the start point and the end point will be described below.

The path output unit 206 outputs the determined path. Outputting the path may include transmitting the path to the vehicle 110. The vehicle 110 may autonomously travel according to the path determined by the server 100. Alternatively, the vehicle 110 may display the path toward a driver of the vehicle 110. Also, the outputting the path may include storing the path in the storage device 106 for future use. Further, the outputting the path may include presenting the path to the user of the server 100 through the output device 104 of the server 100.

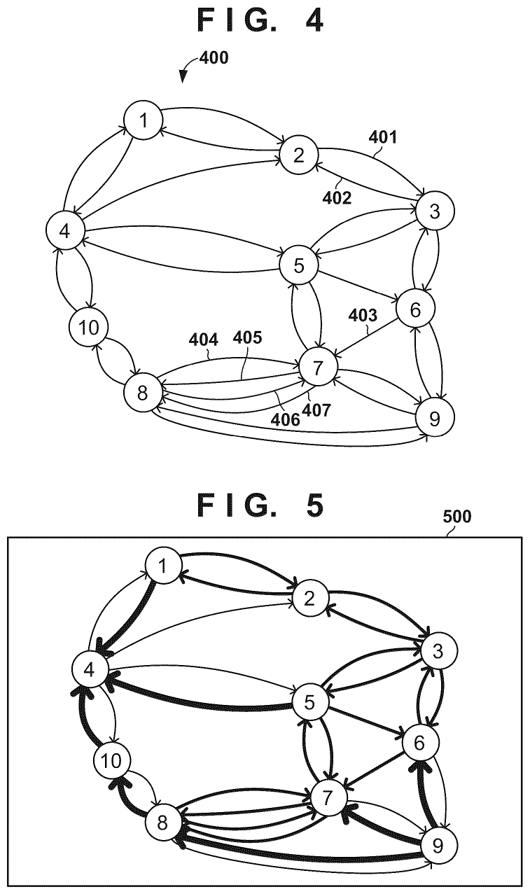

The weight image generation unit 207 generates an image visually indicating the weights assigned to the plurality of edges. The generated image may be transmitted to the vehicle 110 and displayed toward an occupant of the vehicle 110, or may be displayed toward the user of the server 100 using the output device 104 of the server 100. For example, the weight image generation unit 207 generates an image 500 illustrated in FIG. 5. In the image 500, the edge is indicated by a thickness corresponding to the weight of the edge. As the weight of the edge is larger, the edge may be indicated to be thicker, or vice versa. In the image 500, the thickness of the edge is indicated in three stages, but the thickness of the edge may be divided into more stages. Instead of indicating the weight by the thickness of the edge, the weight may be indicated by the color of the edge. Alternatively or in addition, the weight may be visually indicated by displaying a numerical value representing the weight near the edge.

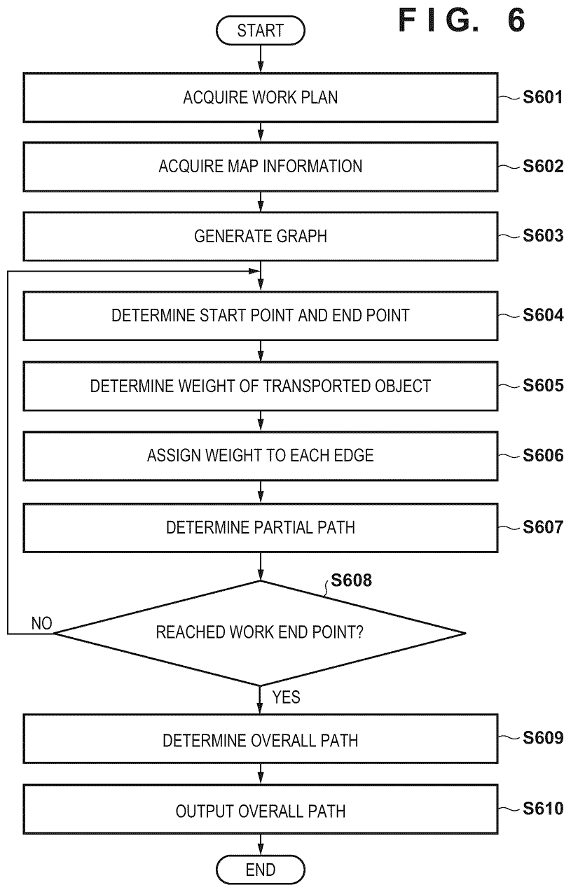

Next, a method executed by the server 100 for planning a path on which the vehicle 110 capable of transporting an object moves will be described with reference to FIG. 6. The method of FIG. 6 may be executed by the processor 101 of the server 100 executing a program read into the memory 102. In the method of FIG. 6, before the vehicle 110 starts work, the server 100 plans a path of the vehicle 110 based on the work plan.

In step S601, the server 100 (specifically, the work plan acquisition unit 202) acquires a work plan related to a transportation work of the vehicle 110. Since the content of the work plan and the method for acquiring the work plan have been described above, redundant description will be omitted. In step S602, the server 100 (specifically, the map information acquisition unit 201) acquires map information of a workplace for the transportation work of the vehicle 110. Since the content of the map information and the method for acquiring the map information have been described above, redundant description will be omitted. In step S603, the server 100 (specifically, the graph generation unit 203) generates a graph representing the workplace for the transportation work of the vehicle 110. Since the method for generating the graph has been described above, redundant description will be omitted.

By repeating steps S604 to S607, the server 100 plans a path on which the vehicle 110 moves based on the work plan acquired in step S601. As described above, the weights to be assigned to the plurality of edges may vary depending on the weight of the object transported by the vehicle 110. Therefore, the path with the minimum sum of the weights may also vary depending on the weight of the object transported by the vehicle 110. Therefore, each time the weight of the object transported by the vehicle 110 changes, the server 100 determines the weights of the plurality of edges based on the changed weight, and determines a path based on the weights. Then, a combination of a plurality of paths (referred to as partial paths) determined in this manner becomes a path (referred to as an overall path) to be finally planned.

In step S604, the server 100 (specifically, the path determination unit 205) selects a start point and an end point based on the work plan acquired in step S601. When step S601 is first executed after the start of execution of the method of FIG. 6, the server 100 selects a node corresponding to a work start point (the point 301 in the example of FIG. 3) as the start point, and selects a node corresponding to a first via-point (the point 302 in the example of FIG. 3) as the end point. When executing step S601 for the second and subsequent times, the server 100 selects an end point in a previous loop as the start point and selects a next work point (via-point or work end point) as the end point.

In step S605, the server 100 (specifically, the weight determination unit 204) determines a weight of the object transported by the vehicle 110 during the movement from the start point to the end point based on the work plan acquired in step S601. In step S606, the server 100 (specifically, the weight determination unit 204) assigns the weight to each edge. Since the method for assigning the weight has been described above, redundant description will be omitted. The value determined in step S505 is used as a weight wi of the object used to calculate the weight assigned to the edge. When the weight of the object transported by the vehicle 110 increases, the vehicle 110 may not be able to pass some roads due to weight limitation. In this case, the server 100 may set the weight of the edge corresponding to the road that cannot be passed to a maximum value, or may remove the edge corresponding to the road that cannot be passed from the graph. In step S607, the server 100 (specifically, the path determination unit 205) determines a path (partial path) having the minimum sum of the weights from the start point to the end point. Since the method for determining the path has been described above, redundant description will be omitted.

In step S608, the server 100 (specifically, the path determination unit 205) determines whether or not the end point of the most recently determined partial path coincides with the work end point. When they are determined to match (“YES” in step S608), the server 100 shifts the processing to step S609, and otherwise (“NO” in step S608), the server 100 shifts the processing to step S604.

In step S609, the server 100 (specifically, the path determination unit 205) determines an overall path by combining the plurality of partial paths determined by repeating steps S604 to S607. In step S610, the server 100 (specifically, the path output unit 206) outputs the determined overall path. Since the method for outputting the path has been described above, redundant description will be omitted.

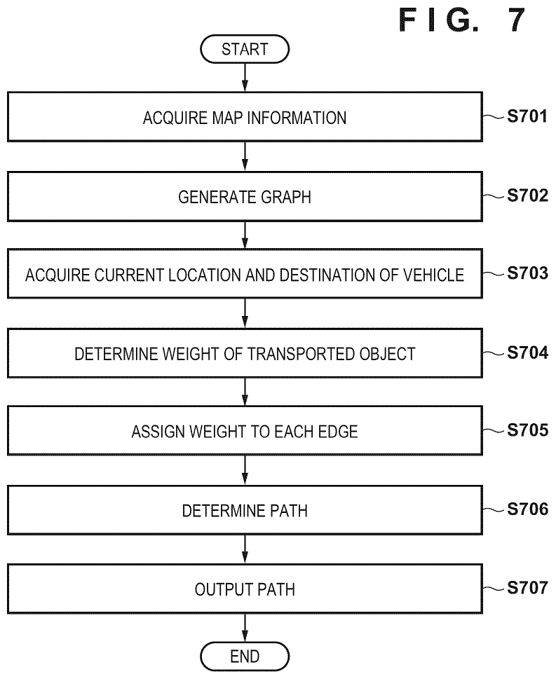

Subsequently, another method executed by the server 100 for planning a path on which the vehicle 110 capable of transporting an object moves will be described with reference to FIG. 7. The method of FIG. 7 may be executed by the processor 101 of the server 100 executing a program read into the memory 102. In the method of FIG. 7, while the vehicle 110 is executing a work, the server 100 plans a path of the vehicle 110 based on information from the vehicle 110.

In step S701, the server 100 (specifically, the map information acquisition unit 201) acquires map information of a workplace for a transportation work of the vehicle 110. Since the content of the map information and the method for acquiring the map information have been described above, redundant description will be omitted. In step S702, the server 100 (specifically, the graph generation unit 203) generates a graph representing the workplace for the transportation work of the vehicle 110. Since the method for generating the graph has been described above, redundant description will be omitted.

In step S703, the server 100 (specifically, the path determination unit 205) acquires a current location and a destination of the vehicle 110. For example, the vehicle 110 transmits its current location and a next work point to the server 100, and the server 100 receives this information. In step S704, the server 100 (specifically, the weight determination unit 204) determines a weight of the object transported by the vehicle 110. For example, the vehicle 110 measures a weight of a current object using the weight sensor 113 and transmits the value to the server 100, and the server 100 receives this information.

In step S705, the server 100 (specifically, the weight determination unit 204) assigns the weight to each edge. Since the method for assigning the weight has been described above, redundant description will be omitted. The value determined in step S604 is used as the weight wi of the object used to calculate the weight assigned to the edge. In step S706, the server 100 (specifically, the path determination unit 205) determines a path having the minimum sum of the weights from the start point to the end point. The current location of the vehicle 110 acquired in step S702 is set as the start point. The destination of the vehicle 110 acquired in step S702 is set as the end point. Since the method for determining the path has been described above, redundant description will be omitted.

In step S607, the server 100 (specifically, the path output unit 206) outputs the determined path. Since the method for outputting the path has been described above, redundant description will be omitted. Specifically, the server 100 may transmit the path to the vehicle 110. Upon receiving the path, the vehicle 110 moves to the destination according to the path. When the destination is not the work end point, the vehicle 110 may request the server 100 to execute steps S703 to S707 using a new current location, a new destination, and a new weight.

In the above-described embodiment, the case where the vehicle 110 autonomously travels has been described. Alternatively, the vehicle 110 may be operated by a human. The human operation may be a remote operation from the outside of the vehicle 110 or may be an operation by a human on the vehicle 110.

In the above-described embodiment, the server 100 generates a graph in steps S503 and S602. Alternatively, a device other than the server 100 may generate a graph, and the server 100 may acquire (for example, receive) the graph from the device.

In the above-described embodiment, the server 100 outputs the path with the minimum sum of the weights of the edges in steps S507 and S606, but the determined path is not limited thereto. For example, the server 100 may output a path with a minimum movement time among a predetermined number (for example, three) of paths from the one with the smaller sum of the weights.

In a case where an order of passing through a plurality of via-points is not specified (for example, in a case where objects are collected by going around a plurality of via-points in an arbitrary order and all the objects are transported to another point), the server 100 may randomly determine the order of passing through the plurality of via-points, or may determine the order of passing through the plurality of via-points so that a final path is the shortest.

In the above-described embodiment, the server 100 functions as a path planning device. Alternatively, the vehicle 110 may function as the path planning device. Specifically, the vehicle 110 may execute the method of FIG. 6 or FIG. 7 described above.

### <Summary of Embodiment>

### <Item 1>

A path planning device (100) for planning a path on which a machine (110) capable of transporting an object moves, the path planning device comprising:
at least one processor circuit and a memory storing instructions, that when executed by the processor circuit, cause the processor circuit to at least:
acquire a graph (400) including a plurality of nodes corresponding to a plurality of points and a plurality of edges corresponding to a plurality of roads connecting the plurality of points;
determine weights to be assigned to the plurality of edges; and
select a start point and an end point from the plurality of nodes, and determine a path from the start point to the end point based on the weights assigned to the plurality of edges,
wherein the weights to be assigned to the plurality of edges are determined based on at least
   a weight of the object transported by the machine during movement on the road corresponding to each edge, and
   a difference in altitude between points corresponding to two nodes connected by each edge

According to this item, since the weight of the edge is determined based on the weight of the object and the difference in altitude, a path with low consumed energy can be appropriately planned.

### <Item 2>

The path planning device according to Item 1, wherein the weights to be assigned to the plurality of edges are determined further based on a distance between the points corresponding to the two nodes connected by each edge.

According to this item, the path with low consumed energy can be more appropriately planned.

### <Item 3>

The path planning device according to Item 1 or 2, wherein the weights to be assigned to the plurality of edges are determined further based on an upper limit speed of the machine during movement on the road corresponding to each edge.

According to this item, the path with low consumed energy can be more appropriately planned.

### <Item 4>

The path planning device according to Item 3, wherein the upper limit speed of the machine is determined to satisfy a condition related to a braking distance of the machine.

According to this item, the path with low consumed energy can be more appropriately planned.

### <Item 5>

The path planning device according to Item 4, wherein the upper limit speed is determined based on the weight of the object transported by the machine.

According to this item, the path with low consumed energy can be more appropriately planned.

### <Item 6>

The path planning device according to any one of Items 1-6, wherein the machine has a regenerative brake mechanism (116), and the weights to be assigned to the plurality of edges are determined further based on an amount of energy recovered by the regenerative brake mechanism.

According to this item, the path with low consumed energy can be more appropriately planned.

### <Item 7>

The path planning device according to any one of Items 1-6, wherein the instructions further cause the processor circuit to acquire a work plan indicating a point where the object is loaded and unloaded, and select the start point and the end point based on the work plan.

According to this item, the start point and the end point of the path can be appropriately determined.

### <Item 8>

The path planning device according to Item 7, wherein each time the weight of the object transported by the machine changes, the weights of the plurality of edges are determined based on the changed weight.

According to this item, the path with low consumed energy can be more appropriately planned.

### <Item 9>

The path planning device according to any one of Items 1-8, wherein the instructions further cause the processor circuit to generate an image (500) visually indicating the weights assigned to the plurality of edges.

According to this item, it is possible to intuitively grasp the weight assigned to the edge.

### <Item 10>

The path planning device according to any one of Items 1-9, wherein the machine is a vehicle (110).

According to this item, the path of the vehicle can be appropriately planned.

### <Item 11>

The path planning device according to any one of Items 1-10, wherein the machine autonomously moves according to the determined path.

According to this item, the machine can autonomously move on the path with low consumed energy.

### <Item 12>

A non-transitory computer-readable storage medium storing a program for operating a computer as the path planning device according to any one of Items 1-11.

According to this item, the path planning device can be provided in a form of the storage medium.

The invention is not limited to the foregoing embodiments, and various variations/changes are possible within the spirit of the invention.

What is claimed is:

1. A path planning device for planning a path on which a machine capable of transporting an object moves, the path planning device comprising:
at least one processor circuit and a memory storing instructions, that when executed by the processor circuit, cause the processor circuit to at least:
acquire a graph including a plurality of nodes corresponding to a plurality of points and a plurality of edges corresponding to a plurality of roads connecting the plurality of points;
determine weights to be assigned to the plurality of edges; and
select a start point and an end point from the plurality of nodes, and determine a path from the start point to the end point based on the weights assigned to the plurality of edges,
wherein the weights to be assigned to the plurality of edges are determined based on at least
a weight of the object transported by the machine during movement on the road corresponding to each edge, and
a difference in altitude between points corresponding to two nodes connected by each edge.

2. The path planning device according to claim 1, wherein the weights to be assigned to the plurality of edges are determined further based on a distance between the points corresponding to the two nodes connected by each edge.

3. The path planning device according to claim 1, wherein the weights to be assigned to the plurality of edges are determined further based on an upper limit speed of the machine during movement on the road corresponding to each edge.

4. The path planning device according to claim 3, wherein the upper limit speed of the machine is determined to satisfy a condition related to a braking distance of the machine.

5. The path planning device according to claim 4, wherein the upper limit speed is determined based on the weight of the object transported by the machine.

6. The path planning device according to claim 1,
wherein the machine has a regenerative brake mechanism, and
the weights to be assigned to the plurality of edges are determined further based on an amount of energy recovered by the regenerative brake mechanism.

7. The path planning device according to claim 1,
wherein the instructions further cause the processor circuit to acquire a work plan indicating a point where the object is loaded and unloaded, and
select the start point and the end point based on the work plan.

8. The path planning device according to claim 7, wherein each time the weight of the object transported by the machine changes, the weights of the plurality of edges are determined based on the changed weight.

9. The path planning device according to claim 1, wherein the instructions further cause the processor circuit to generate an image visually indicating the weights assigned to the plurality of edges.

10. The path planning device according to claim 1, wherein the machine is a vehicle.

11. The path planning device according to claim 1, wherein the machine autonomously moves according to the determined path.

12. A non-transitory computer-readable storage medium storing a program for operating a computer as the path planning device according to claim 1.
